(19) United States
(12) Patent Application Publication
(10) Pub. No.: US 2026/0152222 A1
(43) Pub. Date: Jun. 4, 2026

(54) STORAGE BASKET ASSEMBLY FOR STROLLER

(71) Applicant: WONDERLAND SWITZERLAND AG, Steinhausen (CH)

(72) Inventors: Wanquan ZHU, Dongguan (CN); Xiong YU, Dongguan (CN); Wuqing LIU, Dongguan (CN)

(21) Appl. No.: 19/137,459

(22) PCT Filed: Dec. 12, 2023
(86) PCT No.: PCT/EP2023/085355

§ 371 Date: Jun. 10, 2025

(30) Foreign Application Priority Data
Dec. 12, 2022 (CN) 202223357198.8

(51) Int. Cl. B62B 9/26; B62B 7/00; B62B 9/28

(52) U.S. Cl. CPC B62B 9/26; B62B 7/00; B62B 9/28

(57) ABSTRACT

A storage basket assembly (10) for a stroller (1) is disclosed. The storage basket assembly (10) is arranged on a lower part of a frame (30) of the stroller (1). The storage basket assembly (10) includes a storage basket (100) and an adaptor (200). The storage basket (100) includes a flexible fabric (110) shaped to form a storage cavity (111) adapted to place a child carrying device (20) therein. The adaptor (200) is located on a side wall of the storage cavity (111) and detachably engageable with an engagement member (201) of the child carrying device (20) to fasten the child carrying device (20) when the child carrying device (20) is received in the storage cavity (111). The storage basket assembly (10) further includes a support plate (300) arranged on a side of the fabric (110) which is opposite to the adaptor (200).

### CROSS REFERENCE TO RELATED APPLICATION

The present application claims priority to Chinese patent application No. 2022233571988, filed on Dec. 12, 2022, the entire contents of which are incorporated herein by reference.

### TECHNICAL FIELD

The present disclosure relates to the field of stroller technologies, and in particular, to a storage basket assembly for a stroller and a stroller.

### BACKGROUND

A stroller is used as a child carrier when a user carries a child on foot. An upper part of the stroller is generally provided with child carrying devices such as a carry cot and a seat. A lower part of the stroller is generally provided with a storage basket configured to store items.

### SUMMARY

A first aspect of the present disclosure provides a storage basket assembly for a stroller. The storage basket assembly is arranged on a lower part of a frame of the stroller. The storage basket assembly includes a storage basket and an adaptor. The storage basket has a storage cavity adapted to place a child carrying device therein. The adaptor is located on a side wall of the storage cavity and detachably engageable with an engagement member of the child carrying device to fasten the child carrying device when the child carrying device is received in the storage cavity.

In the first aspect, the storage basket includes a flexible fabric. The fabric is shaped to form the storage cavity.

In the first aspect, the storage basket assembly further includes a support plate. The support plate is attached to the fabric, and the support plate is arranged on a side of the fabric which is opposite to at least a part of the adaptor. At least an upper part of the support plate extends beyond a top end of the adaptor to support a part of the fabric above the adaptor, so that the part of the fabric above the adaptor is kept to be flat.

In the first aspect, a peripheral part of the support plate extends beyond surrounding edges of the adaptor to support a part of the fabric surrounding the adaptor, so that the part of the fabric surrounding the adaptor is kept to be flat.

In the first aspect, the fabric is provided with an interlayer, and the support plate is mounted in the interlayer.

In the first aspect, the support plate is attached to the fabric by sewing.

In the first aspect, a bag is provided on an outer side of the fabric opposite to the adaptor, and the support plate is received in the bag.

In the first aspect, the support plate includes a plastic sheet.

In the first aspect, the adaptor passes through the fabric and is connected to the support plate.

In the first aspect, the adaptor passes through the fabric and the support plate and is fastened to the frame.

In the first aspect, a distance between a top end of the support plate and the top end of the adaptor is no less than half of a distance between the top end of the adaptor and a top end of the side wall of the storage cavity where the adaptor is located.

A second aspect of the present disclosure provides a stroller. The stroller includes a frame, a child carrying device, and the storage basket assembly according to the first aspect.

In the second aspect, the child carrying device includes a seat and/or a carry cot.

### BRIEF DESCRIPTION OF THE DRAWINGS

The accompanying drawings forming part of the present disclosure are intended to provide further understanding of the present disclosure. Exemplary embodiments of the present disclosure and descriptions thereof are intended to explain the present disclosure, and do not constitute any inappropriate limitation on the present disclosure.

FIG. 1 is a schematic structural diagram illustrating a stroller according to an embodiment of the present disclosure.

FIG. 2 is a schematic structural diagram illustrating the stroller in FIG. 1 with a storage basket of the stroller receiving a carry cot.

FIG. 3 is a schematic structural diagram illustrating the stroller in FIG. 1 with the storage basket of the stroller receiving a second seat.

FIG. 4 is a schematic structural diagram illustrating the carry cot to be received in the storage basket of the stroller in FIG. 2.

FIG. 5 is a schematic structural diagram illustrating the second seat to be received in the storage basket of the stroller in FIG. 3.

FIG. 6 is a partially cutaway structural diagram illustrating the stroller in FIG. 1 with the storage basket of the stroller receiving the carry cot.

FIG. 7 is a partial enlarged view of an engagement member in FIG. 4.

FIG. 8 is a partial enlarged view of an adaptor in FIG. 1.

FIG. 9 is a cross-sectional structural view of the stroller in FIG. 1.

FIG. 10 is a partial enlarged view of a region A in FIG. 9.

FIG. 11 is a schematic diagram illustrating a cross-sectional structure of a storage basket and a support plate according to an embodiment.

FIG. 12 is a schematic diagram illustrating a cross-sectional structure of the storage basket and the support plate according to another embodiment.

FIG. 13 is a schematic diagram illustrating a cross-sectional structure of the storage basket and the support plate according to yet another embodiment.

FIG. 14 is a schematic diagram illustrating a side structure of the storage basket and the support plate in FIG. 13.

### DETAILED DESCRIPTION OF THE EMBODIMENTS

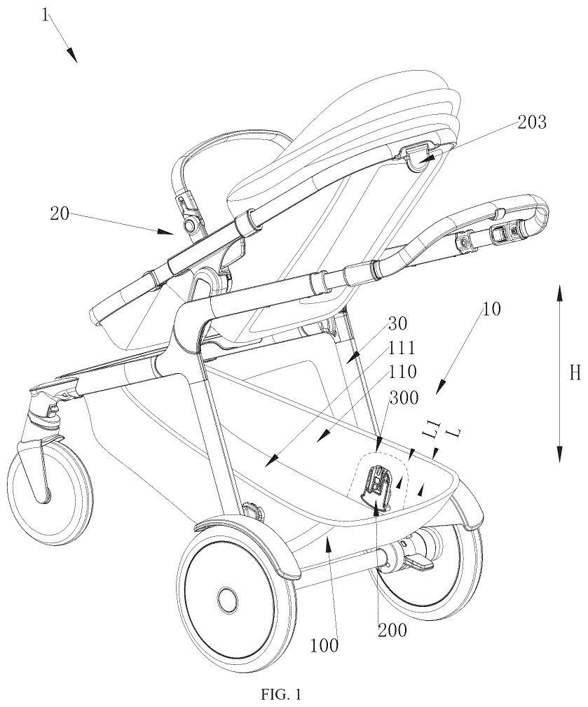

FIG. 1 schematically illustrates a stroller 1 according to an embodiment of the present disclosure. As shown in this figure, the stroller 1 has a storage basket assembly 10, a child carrying device 20, and a frame 30. In a height direction (a direction H as shown in FIG. 1) of the frame 30, the child carrying device 20 is detachably mounted on an upper part of the frame 30, and the storage basket assembly 10 is arranged on a lower part of the frame 30. The storage basket assembly 10 includes a storage basket 100 and an adaptor 200. The storage basket 100 includes a flexible fabric 110, and the fabric 110 is shaped to form a storage cavity 111 adapted to place the child carrying device 20 therein. The storage basket 100 may be, for example, a shopping basket or other storage member configured to store items. The fabric 110 is a woven or non-woven fabric made of natural fibers or synthetic fibers. The adaptor 200 is located on a side wall of the storage cavity 111 and detachably engageable with an engagement member 201 of the child carrying device 20 to fasten the child carrying device 20 when the child carrying device 20 is received in the storage cavity 111.

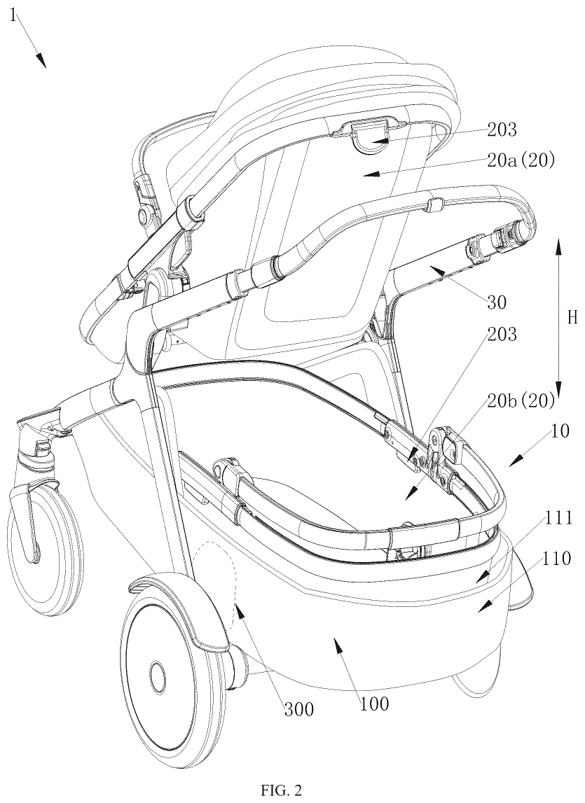

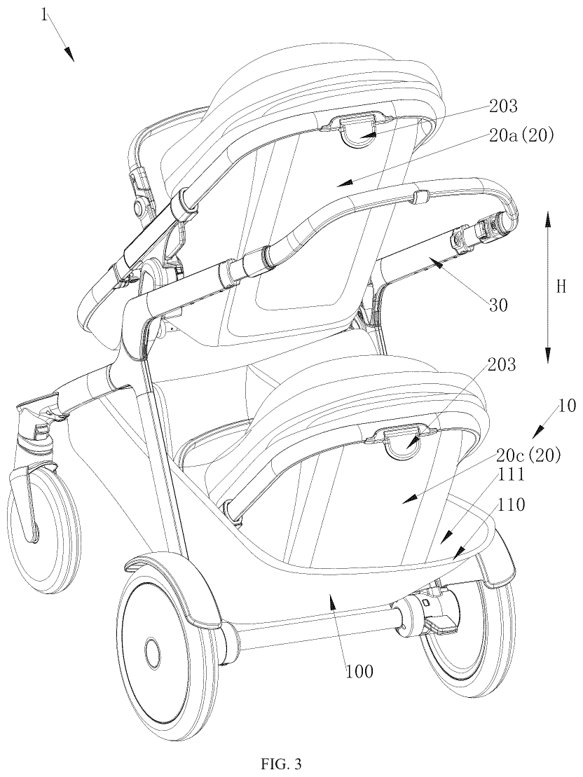

The child carrying device 20 is detachable from the frame 30 and receivable in the storage cavity 111 of the storage basket 100. In addition, the storage cavity 111 of the storage basket 100 may also receive other child carrying devices in addition to the child carrying device 20 mounted on the upper part of the frame 30. The child carrying device includes devices configured to carry children such as a seat and a carry cot. In some embodiments, referring to FIG. 2, in the height direction (a direction H as shown in FIG. 2) of the frame 30, a first seat 20a is mounted on the upper part of the frame 30, and a carry cot 20b is received in the storage basket 100 located on the lower part of the frame 30. In some other embodiments, referring to FIG. 3, in the height direction (a direction H as shown in FIG. 3) of the frame 30, the first seat 20a is mounted on the upper part of the frame 30, and a second seat 20c is received in the storage basket 100 located on the lower part of the frame 30. Those skilled in the art may understand that the child carrying device mounted on the upper part of the frame 30 in these embodiments may alternatively be the carry cot 20b.

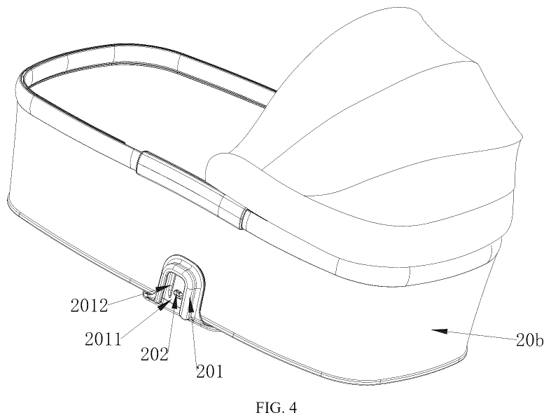

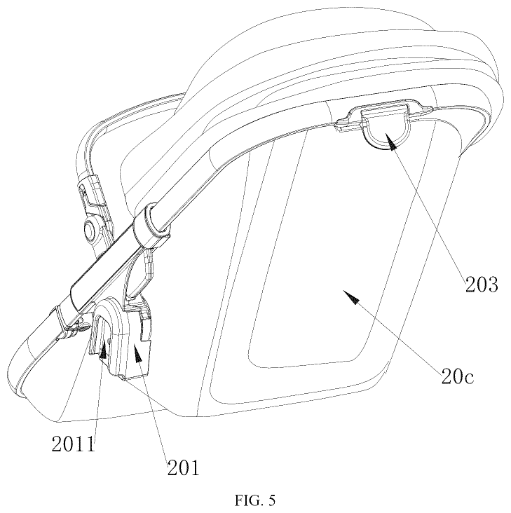

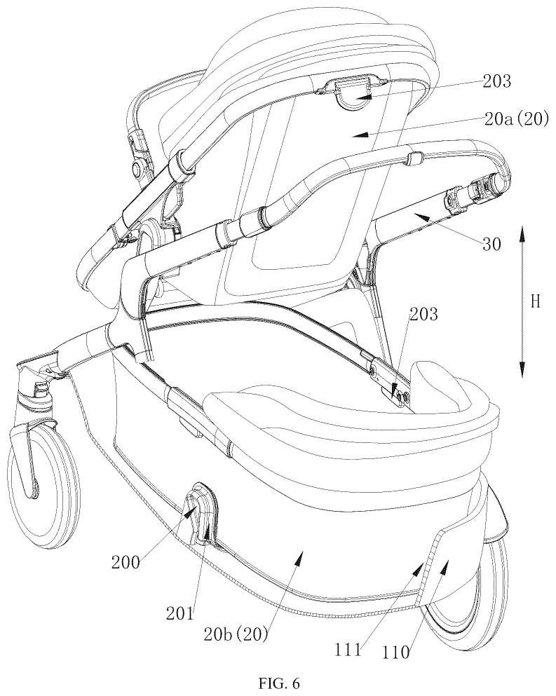

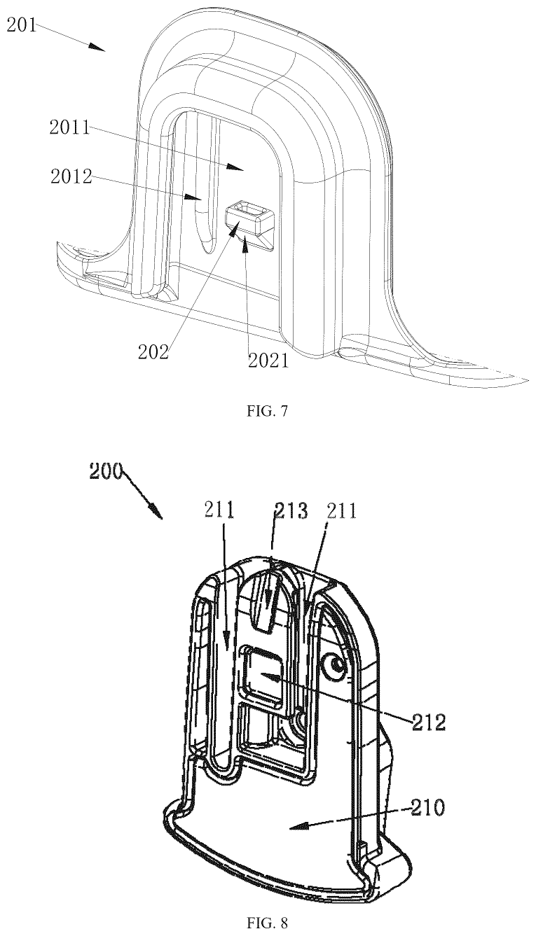

FIG. 4 and FIG. 5 are respectively schematic structural diagrams illustrating the carry cot 20b or the second seat 20c to be received in the stroller 1. Referring to FIG. 1 and FIG. 7, the adaptors 200 located on side walls on two sides of the storage cavity 111 are detachably engageable with the engagement member 201 of the carry cot 20b or the second seat 20c to fasten the carry cot 20b or the second seat 20c when the carry cot 20b or the second seat 20c is received in the storage cavity 111. In this way, when the child carrying device 20 is required to be mounted or received in the storage basket 100, the child carrying device 20 is placed in the storage cavity 111 formed by the fabric 110 from top to bottom along the height direction of the frame 30, the adaptor 200 on the side wall of the storage cavity 111 is detachably engaged with the engagement member 201 on an outer side wall of the child carrying device 20 so that the child carrying device 20 can be stably received in the storage basket 100. When the child carrying device 20 is not required to be received in the storage basket 100, the child carrying device 20 may be disengaged from the storage basket assembly 10 and removed from the storage cavity 111.

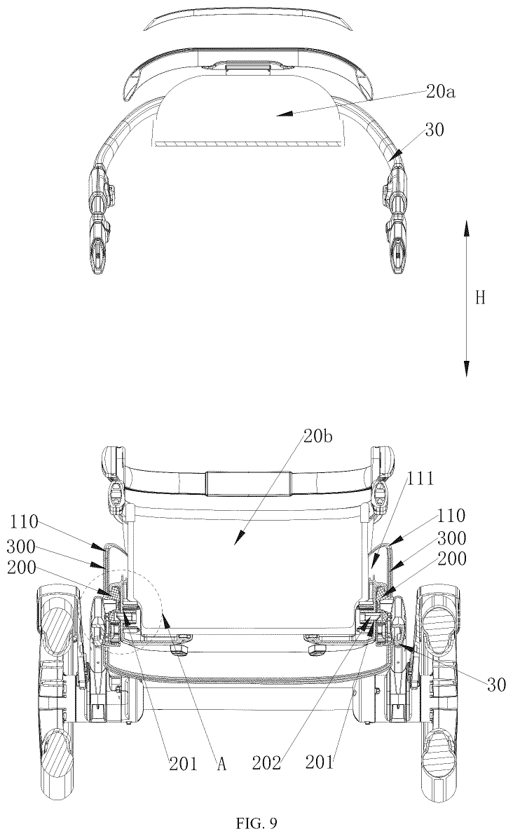

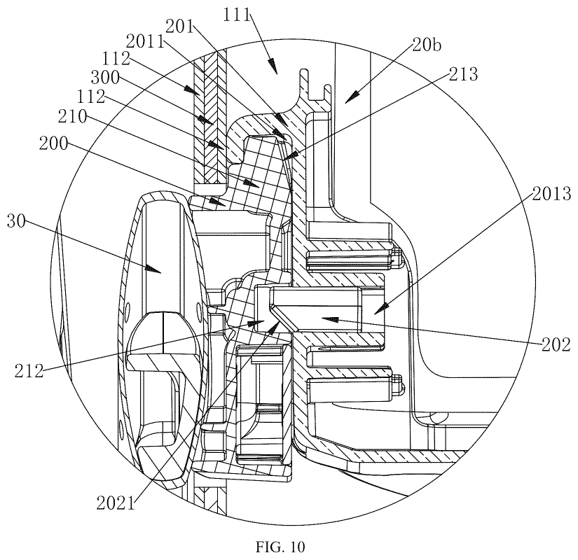

A specific configuration and a connection manner of the adaptor and the engagement member will be described in detail below with reference to the accompanying drawings. FIG. 7 illustrates the engagement member 201 of the carry cot 20b in FIG. 4 in more detail. It may be understood that the engagement member 201 shown in FIG. 7 can also be used as the engagement member 201 of the second seat 20c in FIG. 5, so the engagement member of the second seat 20c in FIG. 5 will not be described again. FIG. 8 illustrates the adaptor 200 in FIG. 1 in more detail. FIG. 9 is a cross-sectional structural view of the stroller shown in FIG. 1. FIG. 10 is a partial enlarged view of a region A in FIG. 9.

Referring to FIG. 7, FIG. 8, and FIG. 10, in some embodiments, the engagement member 201 is provided with a groove 2011, and the adaptor 200 is provided with a protrusion 210 matching the groove 2011. When the child carrying device 20 is received in the storage cavity 111, the groove 2011 is detachably engaged with the protrusion 210 so that the engagement member 201 is detachably engaged with the adaptor 200. Preferably, referring to FIG. 7 and FIG. 8, the groove 2011 is a U-shaped groove, and the protrusion 210 is a U-shaped protrusion matching the U-shaped groove.

Referring to FIG. 7 and FIG. 8, in some embodiments, the engagement member 201 is provided with a first guide portion 2012, and the adaptor 200 is provided with a second guide portion 211 matching the first guide portion 2012. The engagement member 201 is engaged with or disengaged from the adaptor 200, the first guide portion 2012 is movably connected to the second guide portion 211, and one of the first guide portion 2012 and the second guide portion 211 moves relatively along the other of the first guide portion 2012 and the second guide portion 211, to define movement directions of the engagement member 201 and the adaptor 200 during the engagement or disengagement, thereby guiding the engagement member 201 to be engaged with or disengaged from the adaptor 200 along a preset direction (for example, the height direction of the frame 30).

Optionally, referring to FIG. 7, the first guide portion 2012 is a guide rib protruding from a groove wall of the groove 2011, and referring to FIG. 8, the second guide portion 211 is a guide groove provided on a wall surface of the protrusion 210. When the engagement member 201 is engaged with or disengaged from the adaptor 200, the guide rib extends into the guide groove and slides along an extension direction of the guide groove, and the extension direction of the guide groove is consistent with a direction in which the engagement member 201 is engaged with the adaptor 200. In this way, the guide rib and the guide groove can guide the engagement member 201 to be engaged with or disengaged from the adaptor 200, so as to facilitate engagement or disengagement of the engagement member 201 with or from the adaptor 200.

Optionally, referring to FIG. 7 and FIG. 8, at least two guide ribs may be provided, all the guide ribs are arranged at intervals along a same direction, and at least two guide grooves are provided and in one-to-one correspondence to the guide ribs. Through the arrangement of a plurality of guide ribs and guide grooves, the engagement member 201 can be more stably guided to be engaged with or disengaged from the adaptor 200. Preferably, two guide ribs and two guide grooves are provided.

Still referring to FIG. 7, FIG. 8, and FIG. 10, in some embodiments, the child carrying device 20 further includes a locking member 202, and the adaptor 200 is provided with a locking portion 212 matching the locking member 202. When the engagement member 201 is engaged with the adaptor 200, the locking member 202 is locked with the locking portion 212, so that the engagement member 201 and the adaptor 200 are locked together and not easily disengaged from each other. When the engagement member 201 is to be disengaged from the adaptor 200, the locking member 202 and the locking portion 212 are unlocked, so that the engagement member 201 and the adaptor 200 can be disengaged from each other.

Referring to FIG. 7 and FIG. 10, the locking member 202 is movably connected to the engagement member 201. The locking member 202 has a first moving position and a second moving position. When the locking member 202 is at the first moving position, the locking member 202 extends out of a surface of the engagement member 201 and can be locked with the locking portion 212. When the locking member 202 is at the second moving position, the locking member 202 retracts into a third mounting hole 2013 of the engagement member 201 and is unlocked from the locking portion 212.

Referring to FIG. 7, FIG. 8, and FIG. 10, the locking member 202 may include a spring tongue, and the locking portion 212 may include a notch provided on the wall surface of the protrusion 210. When the engagement member 201 is engaged with the adaptor 200 and the spring tongue is at the first moving position, the spring tongue extends out of the groove wall of the groove 2011 and can be inserted into the notch, so that the engagement member 201 and the adaptor 200 are locked and not easily disengaged from each other. When the engagement member 201 is disengaged from the adaptor 200 and the spring tongue is at the second moving position, the spring tongue retracts into the third mounting hole 2013 provided in the groove wall of the groove 2011 and is disengaged from the notch to be unlocked, so that the engagement member 201 and the adaptor 200 are unlocked and can be disengaged from each other.

Referring to FIG. 2, FIG. 3, and FIG. 10, in some embodiments, the child carrying device 20 further includes an elastic member (not shown) and a release button 203. The elastic member is arranged between the engagement member 201 and the spring tongue. The elastic member presses the spring tongue towards the first moving position. The elastic member may include, for example, a coil spring. The release button 203 is operably connected to the spring tongue. The release button 203 has a bounce position and a press position. When the release button 203 is at the bounce position, the spring tongue is at the first moving position and remains in a locked state. When the release button 203 is at the press position, the spring tongue is at the second moving position and is unlocked. In this way, when there is no external force, the release button 203 is at the bounce position. When the engagement member 201 is engaged with the adaptor 200, the spring tongue is automatically at the first moving position under an elastic force of the elastic member, so that the engagement member 201 and the adaptor 200 are automatically locked. When there is a need to disengage the engagement member 201 from the adaptor 200, a force is applied to the release button 203 so that the release button 203 is at the press position, and the release button 203 drives the spring tongue to be at the second moving position, so that the engagement member 201 and the adaptor 200 can be unlocked and disengaged from each other.

The release button 203 may be arranged at any position of the child carrying device 20, for example, at an edge of the carry cot 20b (see FIG. 2), at an upper portion of the back of the second seat 20c (see FIG. 3), or at other positions which are convenient for a user to press. The release button 203 may drive the spring tongue to switch between the first moving position and the second moving position through a traction cable.

It is easy to understand that the release button 203 is operably connected to the spring tongue to drive the spring tongue to be unlocked. In addition to the above description, the release button 203 in the present disclosure may also unlock the spring tongue through other known technologies. Details are not described herein.

Referring to FIG. 8 and FIG. 10, in some embodiments, the adaptor 200 is further provided with a first bevel portion 213. The first bevel portion 213 may be arranged on, for example, the protrusion 210. During the engagement of the engagement member 201 with the adaptor 200, the first bevel portion 213 abuts against the spring tongue and can drive the locking member 202 to move from the first moving position to the second moving position, so that the spring tongue retracts into the third mounting hole 2013 provided in the groove wall of the groove 2011 to allow the groove 2011 to be smoothly engaged with the protrusion 210. After the groove 2011 is engaged with the protrusion 210, a position of the spring tongue corresponds to that of the notch, the spring tongue automatically returns to the first moving position under the elastic force of the elastic member and is inserted into the notch, and the engagement member 201 and the adaptor 200 are automatically locked.

Referring to FIG. 7 and FIG. 10, in some embodiments, the spring tongue is provided with a second bevel portion 2021 abutting against the first bevel portion 213, and during the engagement of the engagement member 201 with the adaptor 200, the first bevel portion 213 squeezes the second bevel portion 2021 to drive the spring tongue to move from the first moving position to the second moving position. The arrangement of the second bevel portion 2021 is conducive to increasing an action area between the first bevel portion 213 and the spring tongue, so that the spring tongue can be more easily driven to move from the first moving position to the second moving position.

It may be understood that although the detachable engagement of the child carrying device 20 with the storage basket assembly 10 is realized by arranging the engagement member 201 on the child carrying device 20 and arranging the adaptor 200 on the storage basket assembly 10 in the foregoing embodiments, in some alternative embodiments, the detachable engagement of the child carrying device 20 with the storage basket assembly 10 may be realized through other existing technologies, such as electromagnetic control or electrical control, and is not limited to the engagement manner presented in the foregoing embodiments.

Referring back to FIG. 1 and referring to FIG. 10 and FIG. 11 together, the storage basket assembly 10 further includes a support plate 300 configured to support the fabric 110 (a contour of the support plate 300 is shown by the dotted line in FIG. 1). The support plate 300 may be, for example, a support plate 300 with predetermined rigidity such as a plastic sheet, a medium density fiberboard, or a metal sheet. For example, the support plate 300 is rigid enough to prevent deformation of the fabric 110 supported by the support plate 300 when the fabric 110 is squeezed. The support plate 300 is attached to the fabric 110, and the support plate 300 is arranged on a side of the fabric 110 which is opposite to at least a part of the adaptor 200. At least an upper part of the support plate 300 extends beyond a top end of the adaptor 200 to support a part of the fabric 110 above the adaptor 200, so that the part of the fabric 110 above the adaptor 200 is kept to be flat.

When the child carrying device 20 is placed in the storage cavity 111 from top to bottom, the support plate 300 supports a part of the fabric 110 above the adaptor 200 to keep the part of the fabric 110 flat, which can prevent squeezing of the part of the fabric 110 above the adaptor 200 by the child carrying device 20. In this way, shielding of the adaptor 200 due to deformation and stacking of the fabric 110 can be prevented, thereby preventing interference of the fabric 110 with the engagement between the engagement member 201 and the adaptor 200, so that the engagement member 201 can be directly engaged with the adaptor 200 during downward movement, which reduces a phenomenon of poor mounting and engagement between the child carrying device 20 and the storage basket 100, and prevents a need for the user to manually level the fabric 110 to complete the engagement between the engagement member 201 and the adaptor 200.

Referring to FIG. 9 and FIG. 10, two support plates 300 and two adaptors 200 are provided. The two adaptors 200 are oppositely arranged on the two inner sides of the storage cavity 111, and the two support plates 300 are arranged in one-to-one correspondence to the two adaptors 200, that is, each support plate 30 and at least a part of a corresponding adaptor 200 are arranged on opposite sides of the fabric 110. As a result, parts of the fabric 110 above each adaptor 200 are supported by the support plates 300 and remain flat.

In some other embodiments, more than two adaptors 200 may be provided, and all the adaptors 200 are arranged at intervals. Preferably, all the adaptors 200 may be arranged at intervals along a circumferential direction of the side wall of the storage cavity 111. The number and positions of the support plates 300 correspond to those of the adaptors 200. In this way, the storage basket assembly 10 can be engaged with the child carrying device 20 through a plurality of adaptors 200, which is conducive to improving robustness of the engagement between the storage basket assembly 10 and the child carrying device 20.

Referring to FIG. 1, in some embodiments, a distance L1 between a top end of the support plate 300 and the top end of the adaptor 200 is no less than half of a distance L between the top end of the adaptor 200 and a top end of the side wall of the storage cavity 111 where the adaptor 200 is located. In this way, a support range of the support plate 300 can be increased, so that the support plate 300 can support the part of the fabric 110 above the adaptor 200 over a larger area and maintain a larger area of flatness, which can better prevent the shielding of the adaptor 200 due to deformation and stacking of the fabric 110 under pressure of the engagement member 201.

Referring to FIG. 1, in some embodiments, a peripheral part of the support plate 300 extends beyond surrounding edges of the adaptor 200 to support a part of the fabric 110 surrounding the adaptor 200, so that the part of the fabric 110 surrounding the adaptor 200 is kept to be flat. In this way, when the child carrying device 20 is placed in the storage cavity 111 from top to bottom, the part of the fabric 110 surrounding the adaptor 200 is kept flat through the arrangement of the support plate 300, which helps to prevent shielding of the engagement member 201 by the part of the fabric 110 surrounding the adaptor 200 during the engagement with the adaptor 200 and ensures that the engagement member 201 can be better directly engaged with the adaptor 200 for mounting.

The support plate 300 may be attached to the fabric 110 in a variety of manners. Several manners in which the support plate 300 is attached to the fabric 110 will be illustrated below. Those skilled in the art will understand that the support plate 300 may be attached to the fabric 110 in other manners, which are not limited to embodiments described below.

Referring to FIG. 11, in some embodiments, the support plate 300 may be connected to the fabric 110 by sewing. This connection manner is simple in processing and low in manufacturing cost. Specifically, the fabric 110 is formed by sewing at least three layers of woven fabric units 112, and the support plate 300 is connected to the woven fabric unit 112 on the inner layer by sewing, so that the support plate 300 is arranged inside the fabric 110, which can better support the entire fabric 110 and keep the fabric 110 flat.

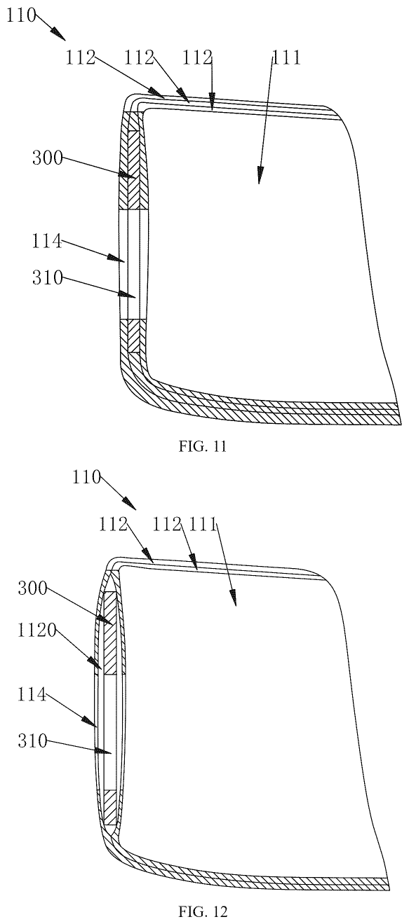

Referring to FIG. 12, in some embodiments, the fabric 110 is provided with an interlayer 1120, and the support plate 300 is mounted in the interlayer 1120. Specifically, the fabric 110 is formed by sewing at least two layers of woven fabric units 112, and the interlayer 1120 is formed between adjacent woven fabric units 112. In this way, the support plate 300 can be arranged inside the fabric 110, which can better support the entire fabric 110 and keep the fabric 110 flat.

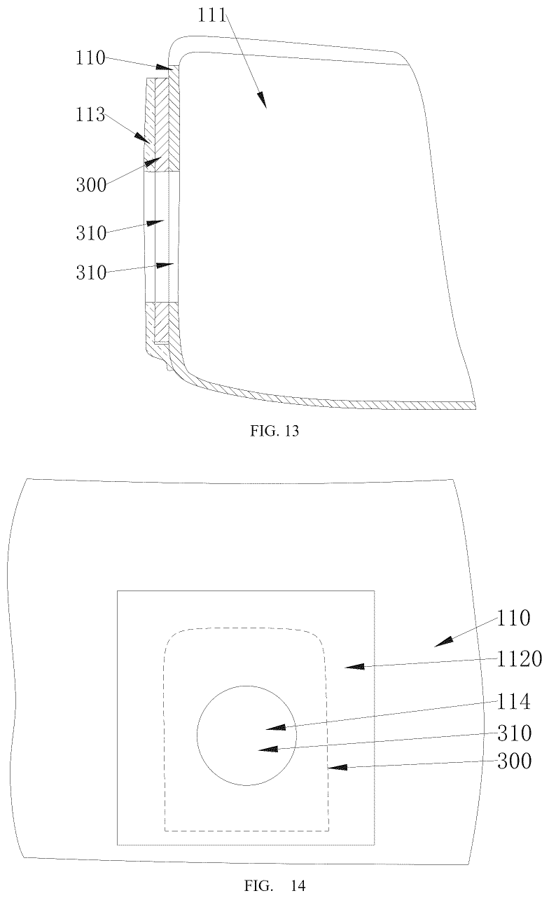

Referring to FIG. 13 and FIG. 14, in some embodiments, a bag 113 is arranged on an outer side of the fabric 110 opposite to the adaptor 200, and the support plate 300 is received in the bag 113, so that the support plate 300 is not exposed to the surface of the storage basket 100, which is more beautiful.

The adaptor 200, the fabric 110, and the support plate 300 may be arranged in a variety of manners.

In some embodiments, referring to FIG. 10, the adaptor 200 passes through the fabric 110 and the support plate 300, and is fastened to the frame 30. In this way, the peripheral part of the support plate 300 extends beyond the surrounding edges of the adaptor 200, thereby ensuring that the part of the fabric 110 surrounding the adaptor 200 is supported by the support plate 300 and is kept to be flat. Specifically, referring to FIG. 11 to FIG. 14, the fabric 110 is provided with a first mounting hole 114 communicated with the storage cavity 111, the support plate 300 is provided with a second mounting hole 310 communicated with the first mounting hole 114, and the adaptor 200 passes through the first mounting hole 114 and the second mounting hole 310, and is fastened to the frame 30. In addition, when the child carrying device 20 is engaged with the adaptor 200 through the engagement member 201, the connection manner in which the adaptor 200 is fastened to the frame 30 helps the adaptor 200 bear a weight of the child carrying device 20, making storage and mounting of the child carrying device 20 more stable. The connection manner in which the adaptor 200 is fastened to the frame 30 may be welding, bolting, or any other suitable connection manner.

In some other embodiments, the adaptor 200 passes through the fabric 110 and is connected to the support plate 300. The arrangement manner can ensure that at least the upper part of the support plate 300 extends beyond the top end of the adaptor 200, thereby ensuring that the part of the fabric 110 above the adaptor 200 is supported by the support plate 300 and is kept to be flat. The adaptor 200 and the support plate 300 may be connected by bonding, bolting, or in any other suitable manner.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the invention. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. A storage basket assembly for a stroller, the storage basket assembly being arranged on a lower part of a frame of the stroller, wherein the storage basket assembly comprises:
a storage basket having a storage cavity adapted to place a child carrying device therein; and
an adaptor located on a side wall of the storage cavity and detachably engageable with an engagement member of the child carrying device to fasten the child carrying device when the child carrying device is received in the storage cavity.

2. The storage basket assembly according to claim 1, wherein the storage basket comprises a flexible fabric shaped to form the storage cavity.

3. The storage basket assembly according to claim 2, wherein the storage basket further comprises a support plate attached to the fabric, wherein the support plate is arranged on a side of the fabric which is opposite to at least a part of the adaptor, and at least an upper part of the support plate extends beyond a top end of the adaptor to support a part of the fabric above the adaptor, so that the part of the fabric above the adaptor is kept to be flat.

4. The storage basket assembly according to claim 3, wherein a peripheral part of the support plate extends beyond surrounding edges of the adaptor to support a part of the fabric surrounding the adaptor, so that the part of the fabric surrounding the adaptor is kept to be flat.

5. The storage basket assembly according to claim 3, wherein the fabric is provided with an interlayer, and the support plate is mounted in the interlayer.

6. The storage basket assembly according to claim 3, wherein the support plate is attached to the fabric by sewing.

7. The storage basket assembly according to claim 2, wherein a bag is provided on an outer side of the fabric opposite to the adaptor, and the support plate is received in the bag.

8. The storage basket assembly according to claim 3, wherein the support plate comprises a plastic sheet.

9. The storage basket assembly according to claim 3, wherein the adaptor passes through the fabric, and is connected to the support plate.

10. The storage basket assembly according to claim 3, wherein the adaptor passes through the fabric and the support plate, and is fastened to the frame.

11. The storage basket assembly according to claim 3, wherein a distance between a top end of the support plate and the top end of the adaptor is no less than half of a distance between the top end of the adaptor and a top end of the side wall of the storage cavity where the adaptor is located.

12. A stroller, comprising:
a frame;
a child carrying device; and
a storage basket assembly comprises:
a storage basket having a storage cavity adapted to place a child carrying device therein; and
an adaptor located on a side wall of the storage cavity and detachably engageable with an engagement member of the child carrying device to fasten the child carrying device when the child carrying device is received in the storage cavity.

13. The stroller according to claim 12, wherein the child carrying device comprises a seat and/or a carry cot.
